(19) United States
(12) Patent Application Publication
(10) Pub. No.: US 2017/0360177 A1
(43) Pub. Date: Dec. 21, 2017

(54) UNIT FOR APPLYING A COSMETIC PRODUCT

(71) Applicant: L'OREAL, Paris (FR)

(72) Inventors: Marcel SANCHEZ, Aulnay Sous Bois (FR); Davide MANICI, Soisy sur Seine (FR); Eric CAULIER, Maignelay (FR)

(21) Appl. No.: 15/527,482

(22) PCT Filed: Nov. 24, 2015
(86) PCT No.: PCT/EP2015/077442

§ 371 Date: May 17, 2017

(30) Foreign Application Priority Data
Nov. 24, 2014 (FR) 1461354

(51) Int. Cl. A45D 40/26; B29C 45/16; B29L 31/00

(52) U.S. Cl. CPC A45D 40/26; B29C 45/1675; A45D 2200/157; B29L 2031/718

(57) ABSTRACT

The present invention relates to a unit for applying cosmetic product for an applicator, said application unit comprising:
a substantially longitudinal holder (34), comprising a first portion (38) suitable for being secured to the receiving area, and a second portion (48) that forms at least one compartment (64) for receiving the cosmetic product;
a mass (36) of cosmetic product to be applied to human keratin materials, said cosmetic product being different from a material (94) that forms the holder.

An outer surface (68) of the mass of cosmetic product includes at least one longitudinal bulge (70, 72) that extends in a continuous manner substantially over the entire second portion of the holder.

The present invention relates to a unit for applying a cosmetic product on human keratin materials, particularly eyelashes or eyebrows.

A “cosmetic product” means any composition such as that defined in Council Directive 93/35/EEC dated Jun. 14, 1993.

More specifically, the present invention relates to a unit for applying a cosmetic product for an applicator, comprising a receiving area of the application unit, said application unit comprising: a substantially longitudinal holder, said holder comprising a first portion suitable for securing said holder removably to said receiving area, and a second portion that forms at least one compartment for receiving the cosmetic product; and a mass of cosmetic product to be applied to human keratin materials, said cosmetic product being different from a material that forms the holder.

From the application EP 1 955 610, an applicator tip is known, exclusively consisting of an eyelash makeup composition, molded and suitable for being mounted by press fitting onto a heating holder shaped in the form of a finger. However, such a tip consisting of cosmetic product mounted directly on the heating holder soils this holder which requires cleaning after each use. Furthermore, handling tips solely consisting of a makeup composition is liable to cause soiling of the user's fingers.

The Applicant has provided solutions to these problems by means of an application unit of the type mentioned above, particularly described in the document WO2011/131907. Such an application unit is typically manufactured according to a two-step injection molding method, as described in said document.

However, the shapes of current application units may give rise to deformation of the holder during certain steps of the production process.

In order to solve this problem, the invention relates to an application unit of the type mentioned above, wherein an outer surface of the mass of cosmetic product includes at least one longitudinal bulge extending continuously, substantially over the entire second portion of the holder.

According to further advantageous aspects of the invention, the application unit comprises one or several of the following features taken in isolation or in any technically possible combination:
the holder comprises at least two reception compartments separated from one another by ribs;
the ribs extend substantially transversally to the holder, an outer surface of said ribs being partially covered by the longitudinal bulge;
the application unit comprises a longitudinal element connecting at least two transversal ribs, an outer surface of said longitudinal element being covered with cosmetic product;
the holder and the mass of cosmetic product are curved with respect to a longitudinal axis, the reception compartments and the mass of cosmetic product being arranged in a concavity of the curve.
the outer surface of the mass of cosmetic product comprises two longitudinal bulges, extending continuously, substantially over the second portion of the holder, said two bulges being arranged symmetrically with respect to a longitudinal plane of symmetry of the holder.

The invention also relates to a method for producing a unit for applying a cosmetic product as described above, said method comprising the following steps: providing a first half-mold having a first cavity and a second half-mold having a second cavity, the first and second cavities defining a first injection volume to form the holder; injecting a first material into the first injection volume to form the holder; separating the first and second half-molds, the holder remaining in the first cavity; providing a third half-mold having a third cavity, the first and second cavities defining a second injection volume to form the mass of cosmetic product; injecting cosmetic product into the second injection volume to form the mass. The third cavity comprises a groove for the formation of the longitudinal bulge.

According to further advantageous aspects of the invention, the method comprises one or several of the following features taken in isolation or in any technically possible combination:
an injection point of the cosmetic product is located substantially on a longitudinal plane of symmetry of the holder;
the third cavity comprises two grooves for the formation of two longitudinal bulges, said grooves being arranged symmetrically with respect to a longitudinal plane of symmetry of the second injection volume.

The invention further relates to an assembly comprising: a unit for applying a cosmetic product as described above; and an applicator comprising a heating receiving area suitable for receiving the application unit, the heating receiving area being suitable for heating the mass of cosmetic product to a temperature inducing a change of state of said cosmetic product.

The invention will be easier to understand in view of the following description, provided solely as a non-restricted example and with reference to the drawings, wherein:

FIG. 1 is a perspective view of an element of an assembly according to an embodiment of the invention;

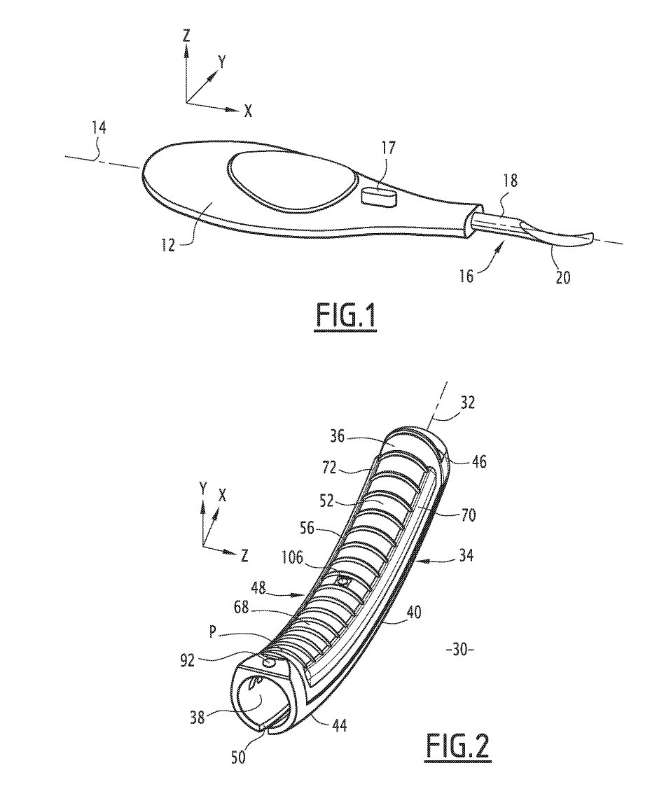

FIG. 2 is a perspective view of an application unit according to an embodiment of the invention;

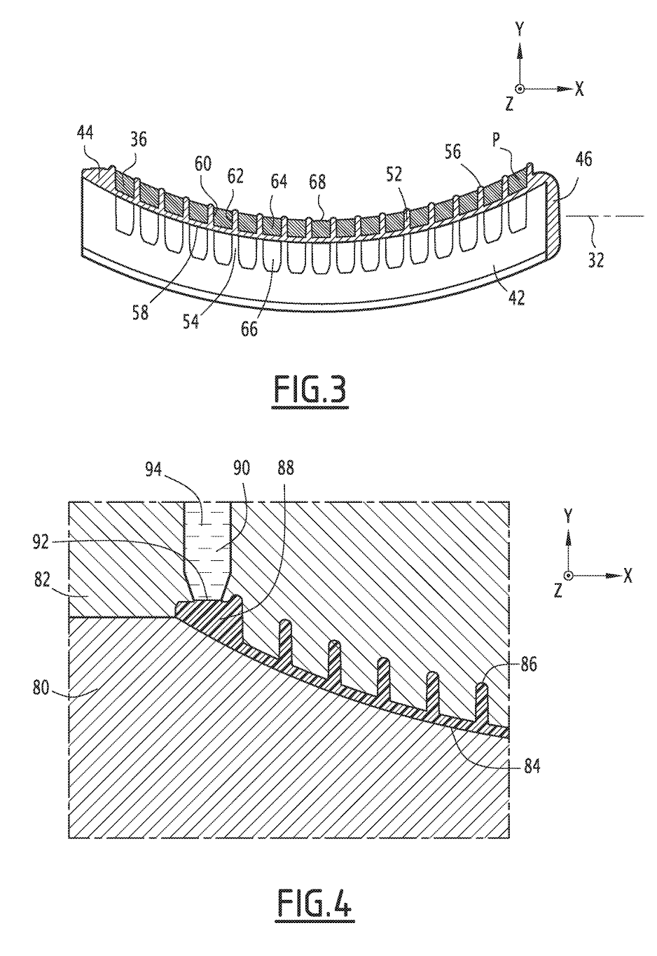

FIG. 3 is a longitudinal cross-section view of the application unit of FIG. 2;

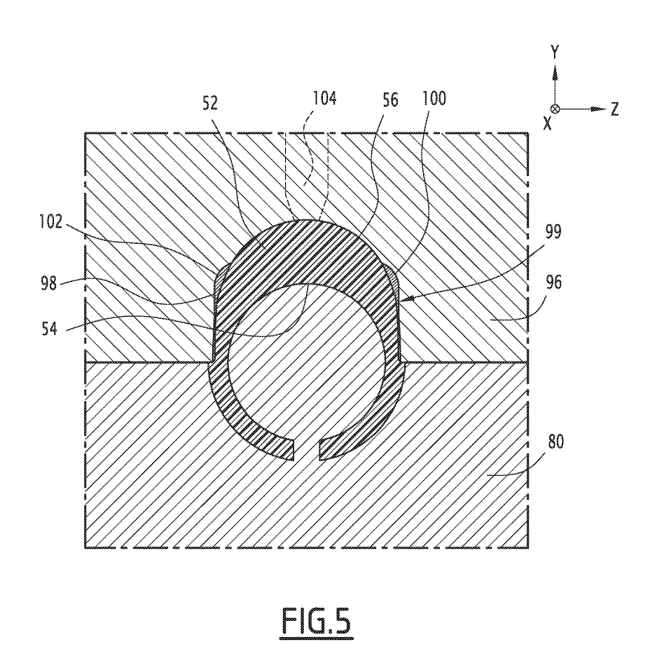

FIG. 4 is a longitudinal cross-section view of the application unit of FIGS. 2 and 3, during a first step of a manufacturing method according to an embodiment of the invention;

FIG. 5 is a transversal cross-section view of the application unit of FIGS. 2 to 4, during a second step of said manufacturing method.

FIG. 1, on one hand, and FIGS. 2 and 3, on the other, represent two elements 10, 30, respectively, of an assembly for applying a cosmetic product, according to an embodiment of the invention. Said assembly is particularly intended for the application of a cosmetic product on human keratin materials, particularly eyelashes or eyebrows.

FIG. 1 represents a heating applicator 10, similar to an applicator described in the document WO2011/131907. The applicator 10 comprises a gripping handle 12 extending essentially along a longitudinal axis 14. The applicator 10 further comprises an application rod 16, which extends the handle 12 along the axis 14.

An orthonormal basis (X, Y, Z) is taken into consideration, the axis 14 being parallel with the direction X.

The rod 16 comprises an electrical heating element, connected to an electrical power source housed in the handle 12. The rod 16 comprises for example a metallic tubular casing 18 containing an electrical insulating core (not shown), said core being traversed by a resistive electrical conductor (not shown) extending over the entire length of the casing 18.

The electrical heating element has for example a rated power between 0.5 and 2 W and makes it possible to attain a temperature greater than 50° C., for example a temperature of 70° C. for an ambient temperature of 20° C.

The electrical power source housed in the handle 12 is for example an electric battery. The heating is actuated by means of a switch 17 situated on the handle 12.

One end of the rod 16, opposite the handle 12, forms a receiving area 20 of a unit for applying cosmetic product. In the embodiment of FIG. 1, the receiving area 20 has a curved shape in a plane (X, Y). The curve is substantially in the arc of a circle. Preferentially, the curve has a radius of curvature between 10 and 100 mm, more preferentially between 20 and 30 mm, for optimal suitability to the application of the product on eyelashes.

FIGS. 2 and 3 show a unit 30 for applying cosmetic product according to an embodiment of the invention. The application unit 30 is suitable for being assembled with the receiving area 20 of the applicator 10 of FIG. 1.

The application unit 30 has an elongated shape and extends substantially along a longitudinal axis 32. When the application unit 30 is assembled with the receiving area 20 of the applicator 10, the axes 14 and 32 are merged.

The same orthonormal basis (X, Y, Z) as in FIG. 1 is taken into consideration, the axis 32 being parallel with the direction X.

The application unit 30 comprises a plastic holder 34 and a mass 36 of cosmetic product P, borne by the holder 34.

The application unit 30, and thus the holder 34 and the mass 36, have a plane of symmetry (X, Y) containing the axis 32 and corresponding to the cutting plane of FIG. 3.

The holder 34 has the shape of a tubular sleeve, so as to be suitable for being fitted onto the rod 16 at the receiving area 20. An internal wall 38 of the holder 34 has a substantially complementary shape with an external shape of the metal casing 18, at the receiving area 20.

The holder 34 comprises two longitudinal sections 40, 42, substantially arranged along the axis 32. At the ends thereof along said axis 32, the longitudinal sections 40, 42 are connected by the proximal 44 and distal 46 ends of the holder 34. The distal end 46 corresponds to the furthest end from the handle 12 when the application unit 30 is assembled with the receiving area 20 of the applicator 10. The distal end 46 comprises a solid wall arranged along a plane (Y, Z). On the other hand, the proximal end 44 is open in order to be able to fit the application unit 30 onto the receiving area 20 of the rod 16.

The longitudinal sections 40, 42 and the proximal 44 and distal 46 ends partially form the internal wall 38 of the holder 34, which is suitable for removably securing said holder 34 onto the receiving area 20.

Moreover, a frame formed by the longitudinal sections 40, 42 and the proximal 44 and distal 46 ends defines an area 48 suitable for containing a cosmetic product.

Preferably, the holder 34 comprises a longitudinal slot 50, separating the longitudinal sections 40, 42. The slot 50 enables the holder 34 to be deformed elastically by molding the shape of the receiving area 20. In this case, an internal cross-section of the holder 34 at rest is slightly smaller than the cross-section of the receiving area 20.

The slot 50 extends preferentially over at least 50% of a length of the holder 34 along the axis 32, more preferentially over at least 90% of said length. The slot extends preferentially in the plane of symmetry (X, Y) of the unit 30.

The slot 50 has for example a width between 0.5 mm and 1.5 mm, measured between the two longitudinal sections 40 and 42.

In the embodiment of FIGS. 2 and 3, the holder 34 is slightly curved in the plane of symmetry (X, Y) of the unit 30. The holder 34 can thus mold the curve of the receiving area 20 as represented in FIG. 1. The slot 50 is situated on the convex side of the curve.

On the concave side of the curve, the area 48 of the holder 34 comprises a series of ribs 52. Each of the ends of the ribs 52 rests on a longitudinal section 40, 42 of the holder 34. In the embodiment in FIGS. 2 and 3, the ribs 52 are parallel with one another and oriented transversally, i.e. along the planes (Y, Z). According to one alternative embodiment described in the document WO2011/131907, the ribs 52 are inclined with respect to the planes (Y, Z).

Preferentially, the holder 34 comprises between two and twenty ribs. Preferentially, the holder 34 comprises an even number of ribs, for reasons detailed hereinafter. In the example in FIGS. 2 and 3, the holder 34 comprises sixteen ribs.

A thickness of the ribs 52, measured along the direction X, is preferentially between 0.5 mm and 1.5 mm.

As seen in FIG. 5, in a cross-section along a plane (Y, Z), the ribs 52 of the holder 34 have a crescent shape, between an internal profile 54 and an external profile 56. The internal profile 54 of the ribs 52 is part of the internal wall 38 of the holder 34.

In the example in FIG. 3, the holder 34 comprises a longitudinal ridge 58 connecting the transversal ribs 52. The ridge 58 is in the form of a thread arranged at the internal profile 54 of the ribs 52. The ridge 58 is part of the internal wall 38 of the holder 34. The ends of the ridge 58 are respectively connected to the proximal 44 and distal 46 ends of the holder 34. The ridge 58 reinforces the structure formed by the transversal ribs 52.

The ridge has for example a substantially rectangular cross-section in a plane (Y, Z), one side of the rectangle having for example a length between 0.1 mm and 0.5 mm.

In the example of FIG. 3, the ridge 58 is arranged in the plane of symmetry (X, Y) of the unit 30. According to an alternative embodiment not shown, the ridge 58 is arranged in a further plane (X, Y). According to a further alternative embodiment not shown, the holder 34 comprises at least two longitudinal ridges connecting the transversal ribs 52, said ridges being preferentially parallel with one another.

As seen in FIG. 3, two consecutive ribs 52 have crescent-shaped surfaces 60, 62 situated facing one another in planes (Y, Z).

The ridge 58 and the surfaces 60, 62 define compartments 64 for receiving cosmetic product.

The holder 34 is for example made of plastic, particularly of a polyolefin such as polyethylene (PE) or polypropylene (PP) or, alternatively, of non-polyolefinic materials such styrene-acrylonitrile (SAN), acrylonitrile-butadiene-styrene (ABS) or polyoxymethylene (POM). These plastic materials are optionally charged with particles or mineral fibers, for example metal oxides, glass or carbon black powder or fiber in order for example to enhance and/or control heat transfer in the holder 34 to the cosmetic product P and/or enhance the rigidity of the holder 34.

The mass 36 of cosmetic product P is rigidly connected to the holder 34 at the area 48 end, the cosmetic product P being particularly received in the compartments 64 between the ribs 52.

The mass 36 has an inner surface 66, particularly situated between the internal profiles 54 of the ribs 52. The inner surface 66 of the mass 36 is continuous with the inner surface 38 of the holder 34. The inner surfaces 38, 66 define a complementary shape of the external shape of the receiving area 20 of the applicator 10. When the application unit 30 is assembled with the receiving area 20, the inner surface 66 of the mass 36 is in contact with the casing 18 of the rod 16.

The mass 36 further has an outer surface 68, intended to come into contact with keratin fibers. At the plane of symmetry (X, Y) of the unit 30, the external profile 56 of the ribs 52 is flush with the outer surface 68 of the mass 36. At said plane of symmetry, the ribs 52 are thus visible from outside the application unit 30.

As seen in FIG. 2, the mass 36 also has two longitudinal bulges 70, 72, partially forming the outer surface 68. The bulges 70, 72 extend continuously along the application unit 30, substantially over the entire area 48 receiving the cosmetic product P. The bulges 70, 72 of cosmetic product P cover the ribs 52, which are thus not visible from the outside at said bulges.

In the example in FIG. 2, the longitudinal bulges 70, 72 are arranged symmetrically with respect to the plane of symmetry (X, Y) of the unit 30. Further arrangements of the bulges are possible. According to alternative embodiments not shown, the application unit 30 comprises a single longitudinal bulge, or more than two bulges.

The cosmetic product P forming the mass 36 is for example an eyelash makeup composition having a property which varies according to the temperature. Said property is for example a smooth-flowing nature, particularly of dₘₐₓ≧ to 5 mm, dₘₐₓ being determined according to the protocol described in paragraphs [0120] to [0127] of the document EP 1 955 610.

The cosmetic product P is for example a composition comprising at least one reversible polymer solid at ambient temperature. The term “solid” denotes a product which does not flow under the effect of gravity at 20° C.

The cosmetic product P comprises for example at least one compound chosen from the following list:
polymers and copolymers comprising at least one alkene monomer, in particular copolymers based on ethylene,
vinyl polyacetate homopolymers,
silicone resins,
film-forming sequenced ethylene polymers, preferably comprising at least one first sequence and at least one second sequence having different vitreous transition temperatures (Tg), said first and second sequences being connected together by an intermediate sequence comprising at least one monomer constituting the first sequence and at least one monomer constituting the second sequence,
diene and styrene copolymers,
sulfopolyesters,
alkene and vinyl acetate copolymers, in particular ethylene and vinyl acetate copolymers;
ethylene and octene copolymers,
vinyl polyacetate homopolymers,
silicone T resins, such as polyphenylsiloxanes,
film-forming sequenced ethylene copolymers, essentially derived from monomers chosen from alkyl methacrylates, alkyl acrylates, and mixtures thereof,
butadiene and styrene copolymers,
copolymers obtained by condensing di-ethyleneglycol, cyclohexane di-methanol, isophthalic acid, sulfoisophthalic acid, and mixtures thereof.

Preferably, the cosmetic product P has a melting point greater than or equal to 50° C., for example approximately 54° C.

Preferentially, the holder 34 bears a mass 36 comprising between 10 mg and 100 mg of cosmetic product P, more preferentially between 20 mg and 50 mg of product, even more preferentially approximately 30 mg of product. This quantity is particularly suitable for single use, making it possible for example to apply makeup on one or two eyelash fringes.

In the example in FIGS. 1 to 3, the receiving area 20 of the applicator 10 and the application unit 30 are curved as defined above. According to one alternative embodiment not shown, the receiving area 20 and the application unit 30 have a substantially rectilinear shape along the axes 14 and 32.

A method for manufacturing the application unit 30 will now be described, with reference to FIGS. 4 and 5. This consists of an injection molding method, similar to the method described in the document WO2011/131907. The term “injection molding” denotes the molding of a part by injecting a material in the fluid state, under a pressure greater than atmospheric pressure, in a closed volume except for a material injection orifice.

A device for manufacturing the application unit 30 particularly comprises a first half-mold 80 and a second half-mold 82.

The first half-mold 80 comprises at least one first cavity 84. Preferentially, the first half-mold 80 comprises a series of identical first cavities 84. The second half-mold 82 comprises at least one second cavity 86. Preferentially, the second half-mold 82 comprises a series of identical second cavities 86. When the first half-mold 80 and the second half-mold 82 are arranged in contact with one another as in FIG. 4, each first cavity 84 coincides with a second cavity 86 so as to define a first volume 88 for injecting material to form the holder 34.

The second half-mold 82 further comprises an injection channel 90 leading to the second cavity 86 at a first injection point 92. By way of example, the first injection point 92, represented in FIG. 2, is situated on the proximal end 44 of the holder 34 in the plane of symmetry (X, Y) of the unit 30.

Preferentially, the second half-mold 82 comprises a series of identical injection channels 90, each of the channels leading to a second cavity 86.

In a first step for manufacturing the application unit 30, the first half-mold 80 and the second half-mold 82 are arranged in contact with one another. A material 94 in the fluid state is then injected into the first injection volume 88 via the injection channel 90, so as to form the holder 34. As represented in FIG. 4, the first injection volume 88 is then entirely filled with material 94.

The material 94 is preferentially injected at a temperature greater than 110° C. so that the material is in the fluid state. Once the injection is complete, the assembly of the first half-mold 80 and the second half-mold 82 is cooled to solidify the material 94.

The first half-mold 80 and the second half-mold 82 are then separated. The holder 34, obtained by cooling the material 94, remains in the first cavity 84 of the first half-mold 80.

The first half-mold 80 is then placed in contact with a third half-mold 96 as represented in FIG. 5.

The third half-mold 96 comprises at least one third cavity 98. The first cavity 84 coincides with the third cavity 98 so as to define, with the holder 34, a second injection volume 99 of cosmetic product P to form the mass 36.

As seen in FIG. 5, the third cavity 98 comprises two longitudinal grooves 100, 102 for the formation of the longitudinal bulges, 70 and 72 respectively. The longitudinal grooves 100, 102 are arranged symmetrically with respect to the plane of symmetry (X, Y) of the unit 30.

Preferentially, the third half-mold 96 comprises a series of identical third cavities 98. When the first half-mold 80 and the third half-mold 96 are arranged in contact with one another as in FIG. 5, each first cavity 84 coincides with a third cavity 98 so as to define a second injection volume 99.

The third half-mold 96 further comprises an injection channel 104, represented by a dotted line in FIG. 5. The injection channel 104 leads to the third cavity 98 at a second injection point 106. By way of example, the second injection point 106, represented in FIG. 2, is situated in the plane of symmetry (X, Y) of the unit 30, substantially at equal distance from the proximal 44 and distal 46 ends.

The holder 34 preferentially comprising an even number of ribs 52, an equal number of ribs 52 is preferentially situated on either side of the second injection point 106.

In the example in FIG. 5, the second injection point 106 is situated away from the longitudinal grooves 100, 102. According to an alternative embodiment not shown, the second injection point is situated in a longitudinal groove.

Preferentially, the third half-mold 96 comprises a series of identical injection channels 104, each of the channels leading to a third cavity 98.

In a second step for manufacturing the application unit 30, the first half-mold 80 and the third half-mold 96 are arranged in contact with one another. The compartments 64 of the holder 34, suitable for receiving the cosmetic product P, are then defined by the ribs 52, the ridge 58, the first cavity 84 and the third cavity 98.

The product P in the fluid state is then injected into the second injection volume 99 via the injection channel 104. The fluid product P first fills the compartment 64 positioned at the second injection point 106. Via the longitudinal grooves 100, 102, the product P then successively fills, gradually, all the compartments 64 of the area 48. The second injection volume 99 is then filled entirely with product P.

The product P is preferentially injected at a temperature greater than 50° C. so that the material is in the fluid state. So as not to melt the holder 34 during the injection of the product P, the injection temperature of the product P is chosen below a melting point of the material 94.

According to an alternative embodiment of the method described above, the material 94 and the product P are injected into the first volume 88 and into the second volume 99 via a plurality of injection points.

Once the injection is complete, the assembly of the first half-mold 80 and the third half-mold 96 is cooled to solidify the product P, forming the mass 36. The first half-mold 80 and the third half-mold 96 are then separated. The unit 30 obtained is then ejected from the first cavity 84 of the first half-mold 80, by means not shown.

During the injection of the product P, the product is diffused via longitudinal grooves 100, 102 formed in the half-mold 96. Therefore, the flow of product P applies little mechanical strain on the ribs 52. On the contrary, in the document WO2011/131907, the product P passes from one compartment to another via a groove formed in the holder, at the base of the ribs. During the injection of the product P, the method described above therefore induces less deformation of the ribs than the method in document WO2011/131907.

Moreover, the presence of the ridge 58 helps stabilize the ribs 52 during the injection of the product P.

The above features therefore make it possible to reduce the percentage of units 30 rejected at the end of the method due to deformation of the holder 34.

The above method for manufacturing the application unit 30 is performed for example by means of a molding press (not shown), as described in the document WO2011/131907.

A method for using an application assembly as described above will now be described. Firstly, a user assembles an application unit 30 with the receiving area 20 of the applicator 10, by particularly fitting the holder 34 onto the rod 16 at the proximal end 44. The application unit 30 is arranged on the receiving area 20 such that the mass 36 of cosmetic product is situated inside the curve of said receiving area 20.

The user then presses the switch 17 on the gripping handle 12, so as to supply the element of the rod 16 with electricity. The temperature of the metal casing 18 increases, causing the mass 36 of cosmetic product to soften or melt. In particular, the bulges 70, 72 soften or melt.

By holding the applicator 10 with the handle 12, the user then moves the receiving area 20 closer to the eyelashes on which makeup is to be applied. So that the curve of the receiving area 20 substantially molds the shape of the edge of the eyelid, the user positions the eye on the concave side of said receiving area 20, the axis 14 being arranged substantially perpendicularly to a plane of symmetry of the face. In FIG. 1, such a plane of symmetry is a plane (Y, Z).

The user then applies the mass 36 on the eyelashes. The product P, softened or molten, is deposited on the eyelashes. In particular, the product P forming the bulges 70, 72 is deposited on the eyelashes.

After use, the user easily removes the application unit 30 from the rod 16, by a reverse movement of the assembly movement. If needed, a new application unit 30 is then assembled with the rod 16. Such a change of application unit can be performed without waiting for the rod 16 to cool.

The assembly described above is for example marketed in kit form, comprising, on one hand, an applicator 10, and, on the other, one or a plurality of application units 30.

According to a first alternative embodiment, all the application units 30 of the same kit are identical. According to a further alternative embodiment, two application units 30 of the same kit comprise a different holder 34 and/or a different mass 36 of cosmetic product P.

1. An application unit for applying a cosmetic product for an applicator comprising a receiving area of the application unit, said application unit comprising:
a substantially longitudinal holder, said holder comprising a first portion suitable for securing said holder removably to the receiving area, and a second portion that forms at least one compartment for receiving the cosmetic product;
a mass of cosmetic product to be applied to human keratin materials, said cosmetic product being different from a material that forms the holder;
the application unit further comprising an outer surface of the mass of cosmetic product includes at least one longitudinal bulge extending continuously, substantially over the entire second portion of the holder.

2. The application unit according to claim 1, wherein the holder comprises at least two reception compartments separated from one another by ribs.

3. The application unit according to claim 2 wherein the ribs extend substantially transversally to the holder, an outer surface of said ribs being partially covered by the longitudinal bulge.

4. The application unit according to claim 3, comprising a longitudinal element connecting at least two transversal ribs, an outer surface of said longitudinal element being covered with cosmetic product.

5. The application unit according to claim 1, wherein the holder and the mass of cosmetic product are curved with respect to a longitudinal axis, the reception compartments and the mass of cosmetic product being arranged in a concavity of the curve.

6. The application unit according to claim 1, wherein the outer surface of the mass of cosmetic product comprises two longitudinal bulges, extending continuously, substantially over the second portion of the holder, said two bulges being arranged symmetrically with respect to a longitudinal plane of symmetry of the holder.

7. A method for producing a unit for applying a cosmetic product according to claim 1, said method comprising the following steps:
providing a first half-mold having a first cavity and a second half-mold having a second cavity, the first and second cavities defining a first injection volume to form the holder;
injecting a first material into the first injection volume to form the holder;
separating the first and second half-molds, the holder remaining in the first cavity;
providing a third half-mold having a third cavity, the first and second cavities defining a second injection volume to form the mass of cosmetic product;
injecting a cosmetic product into the second injection volume to form the mass;
the method being characterized in that the third cavity comprises a groove for the formation of the longitudinal bulge.

8. The method according to claim 7, wherein an injection point of the cosmetic product is situated substantially on a longitudinal plane of symmetry of the holder.

9. The method according to claim 7, for producing a unit for applying a cosmetic product, wherein said application unit comprising:
a substantially longitudinal holder, said holder comprising a first portion suitable for securing said holder removably to the receiving area, and a second portion that forms at least one compartment for receiving the cosmetic product;
a mass of cosmetic product to be applied to human keratin materials, said cosmetic product being different from a material that forms the holder;
the application unit further comprising an outer surface of the mass of cosmetic product includes at least one longitudinal bulge extending continuously, substantially over the entire second portion of the holder; wherein the outer surface of the mass of cosmetic product comprises two longitudinal bulges, extending continuously, substantially over the second portion of the holder, said two bulges being arranged symmetrically with respect to a longitudinal plane of symmetry of the holder; and wherein the third cavity comprises two grooves for the formation of the longitudinal bulges, said grooves being arranged symmetrically with respect to a longitudinal plane of symmetry of the second injection volume.

10. An assembly for applying a cosmetic product, comprising:
a unit for applying a cosmetic product according to claim 1, and
an applicator comprising a heating receiving area suitable for receiving the application unit,
the heating receiving area being suitable for heating the mass of cosmetic product to a temperature inducing a change of state of said cosmetic product.

11. The application unit according to claim 2, wherein the holder and the mass of cosmetic product are curved with respect to a longitudinal axis, the reception compartments and the mass of cosmetic product being arranged in a concavity of the curve.

12. The application unit according to claim 3, wherein the holder and the mass of cosmetic product are curved with respect to a longitudinal axis, the reception compartments and the mass of cosmetic product being arranged in a concavity of the curve.

13. The application unit according to claim 4, wherein the holder and the mass of cosmetic product are curved with respect to a longitudinal axis, the reception compartments and the mass of cosmetic product being arranged in a concavity of the curve.

14. The application unit according to claim 2, wherein the outer surface of the mass of cosmetic product comprises two longitudinal bulges, extending continuously, substantially over the second portion of the holder, said two bulges being arranged symmetrically with respect to a longitudinal plane of symmetry of the holder.

15. The application unit according to claim 3, wherein the outer surface of the mass of cosmetic product comprises two longitudinal bulges, extending continuously, substantially over the second portion of the holder, said two bulges being arranged symmetrically with respect to a longitudinal plane of symmetry of the holder.

16. The application unit according to claim 4, wherein the outer surface of the mass of cosmetic product comprises two longitudinal bulges, extending continuously, substantially over the second portion of the holder, said two bulges being arranged symmetrically with respect to a longitudinal plane of symmetry of the holder.

17. The application unit according to claim 5, wherein the outer surface of the mass of cosmetic product comprises two longitudinal bulges, extending continuously, substantially over the second portion of the holder, said two bulges being arranged symmetrically with respect to a longitudinal plane of symmetry of the holder.

18. A method for producing a unit for applying a cosmetic product according to claim 2, said method comprising the following steps:
providing a first half-mold having a first cavity and a second half-mold having a second cavity, the first and second cavities defining a first injection volume to form the holder;
injecting a first material into the first injection volume to form the holder;
separating the first and second half-molds, the holder remaining in the first cavity;
providing a third half-mold having a third cavity, the first and second cavities defining a second injection volume to form the mass of cosmetic product;
injecting a cosmetic product into the second injection volume to form the mass;
the method being characterized in that the third cavity comprises a groove for the formation of the longitudinal bulge.

19. A method for producing a unit for applying a cosmetic product according to claim 3, said method comprising the following steps:
providing a first half-mold having a first cavity and a second half-mold having a second cavity, the first and second cavities defining a first injection volume to form the holder;
injecting a first material into the first injection volume to form the holder;
separating the first and second half-molds, the holder remaining in the first cavity;
providing a third half-mold having a third cavity, the first and second cavities defining a second injection volume to form the mass of cosmetic product;
injecting a cosmetic product into the second injection volume to form the mass;
the method being characterized in that the third cavity comprises a groove for the formation of the longitudinal bulge.

20. A method for producing a unit for applying a cosmetic product according to claim 4, said method comprising the following steps:
providing a first half-mold having a first cavity and a second half-mold having a second cavity, the first and second cavities defining a first injection volume to form the holder;
injecting a first material into the first injection volume to form the holder;
separating the first and second half-molds, the holder remaining in the first cavity;
providing a third half-mold having a third cavity, the first and second cavities defining a second injection volume to form the mass of cosmetic product;
injecting a cosmetic product into the second injection volume to form the mass;
the method being characterized in that the third cavity comprises a groove for the formation of the longitudinal bulge.
